(19) United States
(12) Patent Application Publication
(10) Pub. No.: US 2024/0308331 A1
(43) Pub. Date: Sep. 19, 2024

(54) Drive Train for a Motor Vehicle

(71) Applicant: ZF Friedrichshafen AG, Friedrichshafen (DE)

(72) Inventors: Philip Dötschel, Friedrichshafen (DE); Matthias Reisch, Ravensburg (DE); Tamas Gyarmati, Bermatingen (DE); Thomas Riedisser, Sigmarszell (DE); Hagen Doepfert, Lindau (DE); Martin Brehmer

(21) Appl. No.: 18/604,751

(22) Filed: Mar. 14, 2024

(30) Foreign Application Priority Data
Mar. 15, 2023 (DE) 10 2023 202 332.6

(51) Int. Cl. B60K 17/16; B60K 1/00; F16H 48/10; F16H 57/021; F16H 57/037; F16H 57/02

(52) U.S. Cl. CPC B60K 17/165; B60K 1/00; F16H 48/10; F16H 57/021; F16H 57/037; B60K 2001/001; F16H 2048/104; F16H 2048/106; F16H 2057/02034; F16H 2057/02052

(57) ABSTRACT

A drive train (1) for a motor vehicle (13) includes a prime mover (2) and a transmission (3) with at least one first planetary gear set (P1) that includes gear set elements with a sun gear (P1.1), a planet carrier (P1.2) and a ring gear (P1.3). The prime mover (2) includes an input shaft (5), which at least indirectly transmits drive power onto an input shaft (4) of the transmission (3). The input shaft (4) is connected to one of the gear set elements of the first planetary gear set (P1) for conjoint rotation. The drive shaft (5) is connected via a spline (6) to the input shaft (4) for conjoint rotation. The spline (6) is arranged axially between a toothing (15) of a first gear set element of the first planetary gear set (P1) and an axial stop (8) configured to axially support the input shaft (4) against the drive shaft (5) in one torque direction.

### CROSS-REFERENCE TO RELATED APPLICATION

The present application is related and has right of priority to German Patent Application No. DE102023202332.6 filed on Mar. 15, 2023, which is incorporated by reference in its entirety for all purposes.

### TECHNICAL FIELD

The invention relates generally to a drive train for a motor vehicle, the drive train including a prime mover and a transmission which is operatively connected thereto and which has at least one first planetary gear set including multiple gear set elements in the form of a sun gear, a planet carrier and a ring gear. The invention further relates generally to a motor vehicle which has at least one drive train of this type.

### BACKGROUND

Drives for motor vehicles are known from the prior art, which include electric machines as prime movers, the drive shaft of which is integrally connected to an input shaft of a transmission drivingly connected to the drive shaft. Furthermore, it is known to mount the drive shaft for rotation with respect to a transmission housing or drive housing via at least two bearing elements. When the input shaft is provided with helical toothing, during the switch of the drive between traction and coasting, the entire drive shaft is pushed back and forth within the axial play of the bearing elements. This results in mechanical strain on the drive shaft and on the entire rotor of the electric machine, which could negatively affect the function of a rotor position sensor which may be present.

### BRIEF SUMMARY

Example aspects of the present invention provide a compact drive train having a prime mover and a transmission which is operatively connected thereto and which is comparatively insensitive to concentricity faults between the prime mover and the transmission and which simplifies a design and assembly of the drive train. In addition, a reliable transmission of force between the transmission components is to be enabled.

A drive train according to example aspects of the invention for a motor vehicle has a prime mover and a transmission, which includes at least one first planetary gear set, with multiple gear set elements in the form of a sun gear, a planet carrier and a ring gear. The prime mover has a drive shaft, which at least indirectly transmits drive power onto an input shaft of the transmission. The input shaft is connected to one of the gear set elements of the first planetary gear set for conjoint rotation. The drive shaft is connected via a spline to the input shaft for conjoint rotation. The spline is arranged axially between a toothing of the first gear set element of the first planetary gear set and an axial stop, which is designed to axially support the input shaft against the drive shaft in one torque direction.

A spline, which is also referred to as fitting toothing, is to be understood as an interlocking shaft-hub connection, in which the drive shaft has external toothing and the first gear set element in the first planetary gear set has internal toothing, or vice versa, the toothings engaging into one another in a substantially interlocking manner and thus forming a multiple-driver connection. The spline can preferably be a serration or a serrated gear, i.e., a serration spline, or involute gearing, i.e., an involute spline. In principle, a spline having straight and parallel tooth flanks is also conceivable. The teeth or the drivers and tooth gaps of the spline are preferably axially straight (i.e., not helical or the like) on the drive shaft and also on the input shaft. The spline transmits torque between the input shaft or the first gear set element which is connected thereto for conjoint rotation, and the drive shaft. Therefore, there is a corotational connection between the first gear set element in the first planetary gear set and the drive shaft, wherein the spline enables the first gear set element in the first planetary gear set to move axially relative to the substantially axially fixed input shaft. The spline, in particular under load, also centers the input shaft or the first gear set element in the first planetary gear set with respect to the drive shaft.

Either the drive shaft is partially arranged spatially within the input shaft, which is connected to the first gear set element in the first planetary gear set for conjoint rotation, or the input shaft is partially arranged spatially within the drive shaft.

The two-piece design of the drive shaft and of the input shaft ensures, in particular during the switch of the drive between traction and coasting, that only the first gear set element in the first planetary gear set is axially movable within the axial play of the first gear set element, while the drive shaft substantially retains axial position.

Preferably, the input shaft and the first gear set element in the first planetary gear set are formed in one piece. Therefore, this single-piece component has two tooth systems, specifically a first tooth system for transmitting torque between the first gear set element and a further gear set element in the first planetary gear set and a second tooth system for implementing the spline with the drive shaft.

The input shaft and the drive shaft are both preferably in the form of a hollow shaft. As a result, one of the output shafts, preferably the first output shaft, can be axially guided through the input shaft and the drive shaft. One of the output shafts, in particular the first output shaft, preferably extends through the transmission and potentially through the prime mover. The respective output shaft therefore extends through the transmission “inline” for transmitting drive power onto the wheel that is operatively connected to the respective output shaft. In this case, the output shafts are advantageously coaxial. Due to the coaxial arrangement of the output shafts, a radially slender design of the transmission can be realized. An arrangement of the output shafts in which the output shafts are in parallel to and offset from one another is also conceivable, for example, by providing a further gear stage which implements an axial offset.

A “shaft” is to be understood as a rotatable component of the transmission, via which associated components of the transmission are connected to each other for conjoint rotation or via which a connection of this type is established upon actuation of an appropriate shift element. The shaft can connect the components to each other axially or radially or also both axially and radially. A shaft is not to be understood exclusively as a, for example, cylindrical, rotatably mounted machine element for transmitting torques, but rather a shaft is also to be understood to refer to general connecting elements that connect individual components or elements to each other, in particular, connecting elements that connect multiple elements to one another for conjoint rotation.

If two components in the transmission are “connected or coupled for conjoint rotation,” this means, as set forth in the invention, that there is a permanent coupling of these components such that the two components cannot rotate independently of each other. This is therefore also to be understood as a permanent rotary joint. In particular, there are no shift elements between the two components, which can be elements in the transmission and/or shafts and/or a non-rotating component in the transmission, but instead, the two components are permanently coupled to each other. An elastically rotating connection between two components is also understood to be permanent, or such that the elements rotate conjointly.

Due to the spline, the first gear set element in the first planetary gear set functions, with the input shaft, as a compensating element, which can compensate for possible concentricity faults between the drive shaft and the transmission, in particular the at least first planetary gear set. Therefore, manufacturing inaccuracies can be compensated for. In addition, the manageability of the drive shaft and of the first gear set element in the first planetary gear set is improved, since the parts that are separate prior to assembly are axially shorter than in the case of a single-piece design of the drive shaft and the input shaft or of the first gear set element in the first planetary gear set. This is advantageous, in particular, for producing the toothing, since the components which have a tooth system are more compact and, therefore, easier to manage.

The axial stop preferably has a first end-face stop surface on the drive shaft and a complementary second end-face stop surface on the input shaft. The stop surfaces can extend around the entire circumference of the respective shaft. A stop which extends around a portion of the circumference is also conceivable. Furthermore, it is conceivable to use at least two, preferably at least three, parallel stop surfaces which are distributed over the circumference and, thus, jointly form the axial stop.

By virtue of the fact that the axial stop is arranged on a side of the spline which is opposite the tooth system of the first gear set element in the first planetary gear set, the tooth system of the first gear set element in the first planetary gear set can be protected against deformation and, if necessary, overload. This is one of the advantages of arranging the spline between the axial stop and the tooth system of the first gear set element in the first planetary gear set, which tooth system is meshed with a further gear set element in the first planetary gear set.

The prime mover is preferably in the form of an electric machine, and the drive shaft is therefore in the form of a rotor shaft of the electric machine. The electric machine includes, in addition to a rotatably arranged rotor which is drivingly connected to the drive shaft or the rotor shaft, a positionally fixed or rotationally and axially fixed stator. The prime mover, in this sense, is preferably connected to an accumulator which supplies the prime mover with electrical energy. Furthermore, the prime mover is preferably controllable by way of an open-loop or closed-loop system by a power electronics system.

Preferably, the drive shaft is rotatably mounted in a positionally fixed component via one first bearing element and at least one second bearing element. The first bearing element is arranged axially between the prime mover, which is in the form of an electric machine, and the transmission, and the second bearing element is arranged on a side of the prime mover, which is in the form of an electric machine, situated opposite the first bearing element. In other words, the rotor of the prime machine is arranged axially between the two bearing elements. The bearing element is preferably a grooved ball bearing. A grooved ball bearing enables transmission of axial forces and radial forces. Other types of bearings that transmit at least radial forces, preferably both radial and axial forces, are also conceivable for the drive train described in the present application. The two bearing elements are to be understood as drive shaft bearings. The two bearing elements are preferably arranged face-to-face.

Preferably, the first bearing element and the second bearing element are axially preloaded by a spring element. The axial preload force preloads the drive shaft towards the second bearing element such that the drive shaft is held in axial position. The second bearing element is axially preloaded at least indirectly via the first bearing element and the drive shaft and is axially at least indirectly supported against the positionally fixed component.

Further preferably, the spring element is in the form of a wave spring. The bearing kinematics and the bearing rigidity are positively affected by the spring element. The preload is applied at the first bearing element, since the first gear set element in the first planetary gear set or the shaft which is connected thereto for conjoint rotation is axially supported against the drive shaft in a first direction. When there is an axial preload at the first bearing element, the axial position of the drive shaft does not change when there is a switch between traction and coasting. As a result, a reliable and faultless function of a position sensor of the prime mover, in particular of a rotor position sensor in a prime mover which is in the form of an electric machine, can be ensured. An adjusting shim can be arranged between the spring element and the housing, the adjusting shim being dimensioned such that a desired spring preloading force is set.

According to one exemplary embodiment of the invention, during traction operation of the drive train, an air gap forms between the input shaft and the drive shaft in the region of the axial stop due to the preload of the spring. By comparison, the axial stop is designed to axially support the first gear set element in the first planetary gear set or the input shaft against the drive shaft during coasting. In other words, during the coasting operation of the drive train, the input shaft is axially supported against the drive shaft, in particular the rotor shaft. Due to the axial stop, in the event of an axial shock, the spring element is also prevented from being “blocked”, which results in damage to the spring element. Therefore, during a traction operation, the spring element is prevented from being overcompressed and damaged in the event of an axial shock towards the transmission.

Preferably, the transmission is an integral differential. This is a combined transmission and differential, which converts as well as distributes torque onto the output shafts, wherein power distribution is also achieved. Therefore, the transmission is a differential gear. In this case, a transmission is therefore provided, which can perform the functions of torque conversion and torque distribution by one single integral assembly. Such a transmission usually has at least two planetary gear sets which are operatively connected to each other. In a transmission of this type, the sums of both wheel torques are not combined in a rotating component to form a single axle torque. Instead, the drive power which is introduced into the first gear set element in the first planetary gear set is divided in the integral differential and, according to the design and connection of the planetary gear sets, is transmitted further into the output shafts which are operatively connected to the planetary gear sets. Therefore, the components of the integral differential can be slimmer due to the respective, comparatively low torque. This also results in smaller and/or fewer components and reduced weight.

An integral differential is to be understood to be a differential which includes a first planetary gear set and at least one further or second planetary gear set which is operatively connected to the first planetary gear set. The first planetary gear set is drivingly connected to the drive shaft, to the second planetary gear set and to a first output shaft. The second planetary gear set is drivingly connected to a second output shaft.

In the case of a differential which has precisely two planetary gear sets, the first planetary gear set is drivingly connected to the input shaft, to the second planetary gear set and at least indirectly to the first output shaft. The second planetary gear set is additionally drivingly connected to the second output shaft. The input torque at the input shaft is convertible by such an integral differential and is distributable and transmittable at a defined ratio onto the two output shafts. Preferably, fifty percent (50%), i.e., half, of the input torque is distributed onto each of the output shafts. Therefore, the differential does not have a rotating component, to which the sum of the two output torques is applied. In other words, the two torques are never combined. Furthermore, the differential has no gears that rotate in a block, or without a rolling motion, when the output rotational speeds of the output shafts are identical. Consequently, the intermeshed components in the differential always rotate in relation to one another, independently of the output rotational speeds of the output shafts.

It is conceivable that the differential also has three or more planetary gear sets which are operatively connected to one another. In this case, one of the planetary gear sets is arranged on the input side and is drivingly connected to the two other planetary gear sets, via which the drive output onto the first and/or the second output shaft(s) takes place. The differential also does not have a rotating component, to which the sum of the two output torques is applied, and therefore the two torques are never combined.

The output shafts of the transmission are designed, in particular, to be operatively connected to a wheel on the vehicle. The respective output shaft can be connected to the associated wheel directly or indirectly, i.e., via, for example, a joint and/or a wheel hub.

The differential is in the form of a planetary transmission having at least two planetary gear sets and the gear set elements sun gear, ring gear and multiple planet gears which are guided by a planet carrier on a circular path around the sun gear. A “planetary gear set” is to be understood as a unit having multiple gear set elements in the form of a sun gear, a ring gear and a planet carrier, wherein at least one planet gear, preferably multiple planet gears, is/are rotatably mounted on the planet carrier, the planet gear(s) being guided by the planet carrier on a circular path around the sun gear, wherein the planet gear or the planet gears is/are meshed with the ring gear and/or the sun gear depending on the design of the planetary gear set.

In this sense, the transmission also includes a second planetary gear set, which has multiple gear set elements in the form of a sun gear, a planet carrier and a ring gear, wherein a second gear set element in the first planetary gear set is at least indirectly connected to the first output shaft for conjoint rotation and a third gear set element in the first planetary gear set is at least indirectly connected to a first gear set element in the second planetary gear set for conjoint rotation, wherein a second gear set element in the second planetary gear set is connected to a positionally fixed component for conjoint rotation and a third gear set element in the second planetary gear set is at least indirectly connected to the second output shaft for conjoint rotation, and wherein a first output torque is at least indirectly transmittable onto the first output shaft by the first planetary gear set, and a support torque of the first planetary gear set is convertible in the second planetary gear set such that a second output torque, which corresponds to the first output torque, is transmittable onto the second output shaft. The planetary gear sets can be axially adjacent to one another or radially nested.

A positionally fixed component is to be understood, as set forth in the invention, to be a rotationally and axially fixed component of the transmission, for example, the transmission housing. The positionally fixed component can therefore be fixed to the housing. The term “fixed to the housing” is to be understood to mean that relative motion does not take place or cannot take place between the gear set element which is fixed to the housing and the positionally fixed component of the transmission.

According to one exemplary embodiment, the first gear set element in the first planetary gear set is supported with respect to a second gear set element in the first planetary gear set via an axial bearing. In the traction operation, the axial bearing acts as an axial stop for the first gear set element in the first planetary gear set. The axial bearing is preferably an axial needle bearing. Alternatively, the axial bearing is a plain bearing. By the axial bearing, the first and the second gear set elements in the first planetary gear set are axially supported against each other in the traction operation. In addition, a floating mounting of the first gear set element in the first planetary gear set can be implemented by the axial bearing.

Preferably, a thrust washer is arranged axially between the axial bearing and the first gear set element in the first planetary gear set. The thrust washer is provided for adjusting an axial play between the first gear set element in the first planetary gear set and the second gear set element in the first planetary gear set. The thrust washer is an optional component in the transmission.

Due to the axial stop, the input shaft comes to rest axially against the drive shaft in one torque direction. At the input shaft or at the sun gear in the first planetary gear set, which is connected to the input shaft, a torque can act in a first torque direction and in an opposite, second torque direction. The torque direction can reverse when the direction of travel of the vehicle changes from forward travel into travel in reverse, or vice versa, or when a switch between a traction operation and a coasting operation, and vice versa, takes place in the drive train. A distinction can be made between two cases. In a first case, in the traction operation, the preferably helically-toothed sun gear in the first planetary gear set presses towards the drive shaft, and the axial force is generated by the helical teeth on the sun gear in the first planetary gear set. The axial stop operates in the traction operation and the axial force is absorbed via the second bearing element of the drive shaft. The advantage is that the axial bearing is loaded to a lesser extent in the traction operation and the second bearing element generates fewer losses under an axial load, such that an efficiency advantage is achievable. In a second case, in the traction operation, the preferably helically-toothed sun gear in the first planetary gear set presses towards the axial bearing, and the axial stop does not operate. The forces of the first and the second planetary gear sets cancel each other out at the axial bearing. The advantage is that an axial force does not act outwards onto the housing of the transmission. In other words, the bearing elements, in particular the second bearing element, are/is loaded by the wave spring only due to the axial preload, which, in turn, results in fewer losses in the second bearing element. In addition, the axial bearing is loaded only with the axial forces from the planetary gear sets. The two cases are to be considered in reverse for a coasting operation of the drive train.

In principle, the planetary gear sets in the transmission, in particular in the integral differential, can be arbitrarily arranged with respect to one another and arbitrarily operatively connected to one another in order to implement a desired gear ratio. According to one exemplary embodiment, the first gear set element in the planetary gear set is in the form of a sun gear, the second gear set element in the planetary gear set is in the form of a planet carrier and the third gear set element in the planetary gear set is in the form of a ring gear. The drive shaft is therefore connected via the spline to the input shaft of the transmission and the sun gear in the first planetary gear set for conjoint rotation, wherein the planet carrier in the first planetary gear set is at least indirectly connected to the first output shaft for conjoint rotation and the ring gear in the first planetary gear set is at least indirectly connected to the sun gear in the second planetary gear set for conjoint rotation. In particular, the ring gear in the first planetary gear set is connected to the sun gear in the second planetary gear set for conjoint rotation via a coupling element, in particular a coupling shaft or the like. In addition, the planet carrier in the second planetary gear set is arranged in a rotationally fixed manner or is fixed to the housing. In addition, the ring gear in the second planetary gear set is at least indirectly connected to the second output shaft for conjoint rotation. Further components, for example, intermediate shafts or coupling shafts, can also be arranged between the aforementioned components, i.e., the gear set elements in the planetary gear sets. Therefore, everything described in the preceding parts of the description and in the following parts of the description applies for the first gear set element in the first planetary gear set, in particular for the sun gear in the first planetary gear set.

Preferably, the planetary gear set is in the form of a negative planetary gear set or a positive planetary gear set. A negative planetary gear set corresponds to a planetary gear set including a planet carrier, on which first planet gears are rotatably mounted, and including a sun gear and a ring gear, wherein the teeth on at least one of the planet gears meshes with the teeth on the sun gear as well as with the teeth on the ring gear, as a result of which the ring gear and the sun gear rotate in opposite directions when the sun gear rotates while the carrier is held. A positive planetary gear set differs from the negative planetary gear set in that the positive planetary gear set has first and second or inner and outer planet gears which are rotatably mounted on the planet carrier. The teeth of the first or inner planet gears mesh with the teeth of the sun gear and with the teeth of the second or outer planet gears. In addition, the teeth of the outer planet gears mesh with the teeth of the ring gear. As a result, the ring gear and the sun gear rotate in the same direction when the planet carrier is held.

In the design of one or both planetary gear set(s) as a positive planetary gear set, the connection of the planet carrier and the ring gear is interchanged and the absolute value of the stationary transmission ratio is increased by one (1). Correspondingly, this is also possible the other way around when a negative planetary gear set is to be provided in place of a positive planetary gear set. In this case, as compared to the positive planetary gear set, the ring gear connection and the planet carrier connection would also need to be interchanged, and a stationary transmission ratio would need to be reduced by one (1) and the sign changed. Within the scope of the invention, the two planetary gear sets are each preferably designed as a negative planetary gear set, however. Negative planetary gear sets have a comparatively high efficiency and can be easily arranged axially next to one another and/or radially nested.

It is also conceivable to form one or both planetary gear set(s) as stepped planetary gear sets. Each stepped planetary gear of the particular stepped planetary gear set preferably has a first gear wheel with a second gear wheel, which is connected thereto for conjoint rotation. The first gear wheel is preferably meshed, for example, with the sun gear and the second gear wheel is therefore meshed with the ring gear, or vice versa. These two gear wheels can be connected to each other for conjoint rotation, for example, via an intermediate shaft or a hollow shaft. In the case of a hollow shaft, the hollow shaft can be rotatably mounted on a pin of the planet carrier. Preferably, the two gear wheels of the stepped planetary gear set have different diameters and numbers of teeth in order to adjust a transmission ratio. Composite planetary gear sets are also conceivable.

Example aspects of the invention incorporate the technical teaching that at least the sun gear in the first planetary gear set is helically toothed. Correspondingly, the other gear set elements in the first planetary gear set are also helically toothed. According to one exemplary embodiment in which the transmission has two operatively connected planetary gear sets, the gear set elements in the second planetary gear set are also helically toothed. It is advantageous to select the helix direction of the toothing such that the first gear set element in the first planetary gear set, as the sun gear or the input shaft which is preferably integrally connected to the sun gear and is coupled via the spline to the drive shaft, presses axially against the axial needle bearing, which has a greater load-bearing capacity, during traction operation of the drive. In the coasting operation, which generally has lower loads than the traction operation, the first gear set element in the first planetary gear set then presses against the second bearing element via the drive shaft. These loads are compensated for by the spring element, wherein the axial stop protects, in particular, the spring element against overload.

Preferably, the input shaft is radially secured on the drive shaft, or vice versa, via at least one first centering. In other words, a centering effect of the spline, which is achieved under load, is supported by the at least first centering. In addition, the at least first centering also implements the centering effect in operating situations in which centering is not carried out by the spline. Such an operating situation exists, for example, when a load is not transmitted between the drive shaft and the input shaft or the first gear set element in the first planetary gear set. Either the first gear set element in the first planetary gear set or the input shaft is centered with respect to the drive shaft or the drive shaft is centered with respect to the first gear set element in the first planetary gear set or the input shaft.

The at least first centering is carried out by guiding, with low clearance, either the drive shaft into the input shaft or, alternatively, the input shaft into the drive shaft. Therefore, there is a type of press fit, which has less radial play of the drive shaft relative to the input shaft, but allows for axial flexibility of the input shaft. As a result, a quieter operation of the first gear set element in the first planetary gear set, in particular at high rotational speeds and/or low load, can be ensured. Not least because of the particular centering, the input shaft or the first gear set element in the first planetary gear set is aligned coaxially with the drive shaft.

Alternatively, the at least one first centering is implemented as tooth tip centering on the spline. The input shaft is aligned with respect to the drive shaft via the tooth tip centering. By providing a tooth tip centering in the spline, further centerings, for example, in the form of a press fit or the like, can be dispensed with. In this sense, the input shaft is radially secured on the drive shaft via a tooth tip centering on the spline, and vice versa.

When the first centering is in the form of a press fit or the like, according to an example development of the invention, the input shaft is radially secured on the drive shaft, or vice versa, via at least one second centering. The second centering is preferably implemented identically to the first centering, and so reference is made to the comments presented with respect to the first centering.

According to one exemplary embodiment, the spline is arranged axially between the two centerings. The spline having the two centerings is therefore arranged axially between the axial stop and the toothing of the first gear set element in the first planetary gear set, such that axial forces do not act directly on the toothing of the first gear set element in the first planetary gear set. Due to the specific arrangement of the two centerings axially adjacently to the spline, the drive shaft can be effectively prevented from tilting in relation to the first gear set element in the first planetary gear set, or vice versa. In addition, the absence of radial play between the first gear set element in the first planetary gear set and the drive shaft is improved by a further centering. Alternatively, the centering can also take place directly in the toothing. For example, by centering the addendum circle of the shaft toothing in the root circle of the hub toothing, or vice versa.

The term “operatively connected” is to be understood to mean a permanent connection between two components, the permanent connection being provided for permanently transmitting drive power, in particular rotational speed and/or torque. The connection can be implemented directly, i.e., as a corotational connection, or via a fixed ratio. The connection can be implemented, for example, via a fixed shaft, a toothing, in particular a spur gear tooth system, and/or a wrap-around.

The term “at least indirectly” is to be understood to mean that two components are (operatively) connected to each other via at least one other component, located between the two components, or that the two components are directly connected to each other. Therefore, other components can be arranged between shafts or gear wheels, the components being operatively connected to the shaft or to the gear wheel.

A motor vehicle according to example aspects of the invention has at least one drive train as described above. The drive train according to example aspects of the invention can therefore be used in a motor vehicle, in particular, an automobile (for example, a passenger car weighing less than three and a half (3.5) tons), a bus, or a truck (busses and trucks can weigh more than three and a half (3.5) tons). The motor vehicle is, in particular, an electric vehicle or a hybrid vehicle when the prime mover of the drive train is an electric machine. The motor vehicle has at least two axles, one of the axles forming an axle of the motor vehicle, which is drivable by the drive train. The drive train according to example aspects of the invention is operatively arranged on this drive axle, wherein a drive power of the prime mover is transmited via the transmission onto the wheels on the motor vehicle, which are operatively connected to the output shafts. It is also conceivable to provide a drive train according to example aspects of the invention for each axle of the motor vehicle, such that each axle is a driven axle.

The definitions presented above and comments presented regarding technical effects, advantages, and advantageous embodiments of the drive train according to example aspects of the invention also apply similarly for the motor vehicle according to example aspects of the invention, and vice versa.

### BRIEF DESCRIPTION OF THE DRAWINGS

Example embodiments of the invention are explained in greater detail in the following with reference to the drawings, in which:

FIG. 1 shows a simplified schematic view of a motor vehicle according to example aspects of the invention with a drive train according to example aspects of the invention;

FIG. 2 shows a highly schematicized view of a transmission of the drive train according example aspects of to the invention from FIG. 1;

FIG. 3 shows a first schematic longitudinal sectional representation of one part of the drive train from FIG. 1 and FIG. 2 for illustrating a bearing arrangement;

FIG. 4 shows a second schematic longitudinal sectional representation of one part of the drive train shown in FIG. 1 through FIG. 3 for illustrating a connection between a drive shaft of a prime mover and an input shaft of the transmission, the connection transmitting a torque and axial forces; and

FIG. 5 shows a schematic longitudinal sectional representation of one part of the drive train according to example aspects of the invention, according to a second embodiment for illustrating the connection between the drive shaft of the prime mover and the input shaft of the transmission, the connection transmitting a torque and axial forces.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

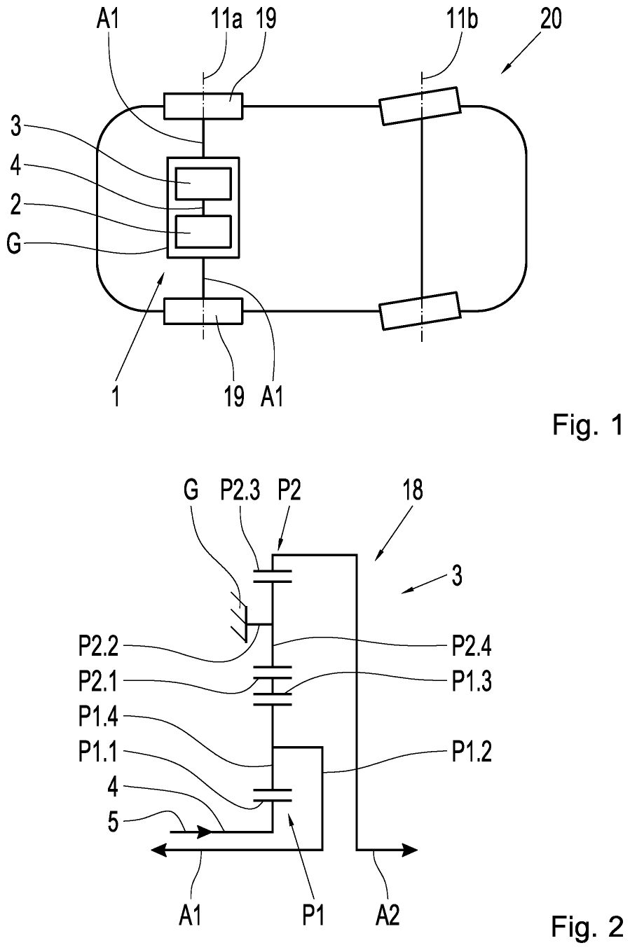

FIG. 1 shows a motor vehicle 13 with two axles 11a, 11b, and a drive train 1 according to the invention is drivingly arranged at the first axle 11a. The motor vehicle 13 is an electric vehicle in this case, the vehicle 13 being driven purely electrically by the drive train 1. The first axle 11a can be both a front axle and a rear axle of the motor vehicle 1 and forms a driven axle of the motor vehicle 1. In this case, the first axle 11a is the rear axle or the non-steerable axle of the motor vehicle 1.

The drive train 1 includes a prime mover 2, which is in the form of an electric machine, and a transmission 3 which is operative connected thereto. The configuration and the arrangement of the transmission 3 is explained in greater detail in the following figures. The design of the prime mover 2 is not shown here. The prime mover 2 or the electric machine also has an accumulator which supplies the prime mover 2 with electrical energy, and a power electronics system for the open-loop control and closed-loop control of the prime mover 2. By energizing a stator (not shown here), a rotor 10, which is arranged so as to be rotatable with respect to the stator, is set into rotational motion relative to the stator, the rotor being connected, preferably integrally, to a drive shaft 5 for conjoint rotation and being connected to an input shaft 4 of the transmission 3 for conjoint rotation, the input shaft 4 of the transmission 3 being non-rotatably accommodated on the drive shaft 5.

The transmission 3 shown in FIG. 2 is a differential gear and has two planetary gear sets P1, P2 which are operatively connected to each other. The output shafts A1, A2 extend in opposite directions toward the wheels 14 according to FIG. 1. The prime mover 2 is coaxial with the transmission 3 which is in the form of an integral differential 18. The drive power of the prime mover 2 is directed via the drive shaft 5 and the input shaft 4 into the transmission 3, converted there by the differential 18 and divided at least indirectly onto a first output shaft A1 toward the left and a second output shaft A2 toward the right.

The output shafts A1, A2, which are coaxial with each other, are each indirectly connected to a wheel 14 (shown in FIG. 1) on the first axle 11a in order to drive the vehicle 1. Joints and wheel hubs (not shown here) can be arranged between the respective wheel 14 and the output shafts A1, A2 in order to compensate for possible inclinations of the output shafts A1, A2. These are not shown or described in greater detail here.

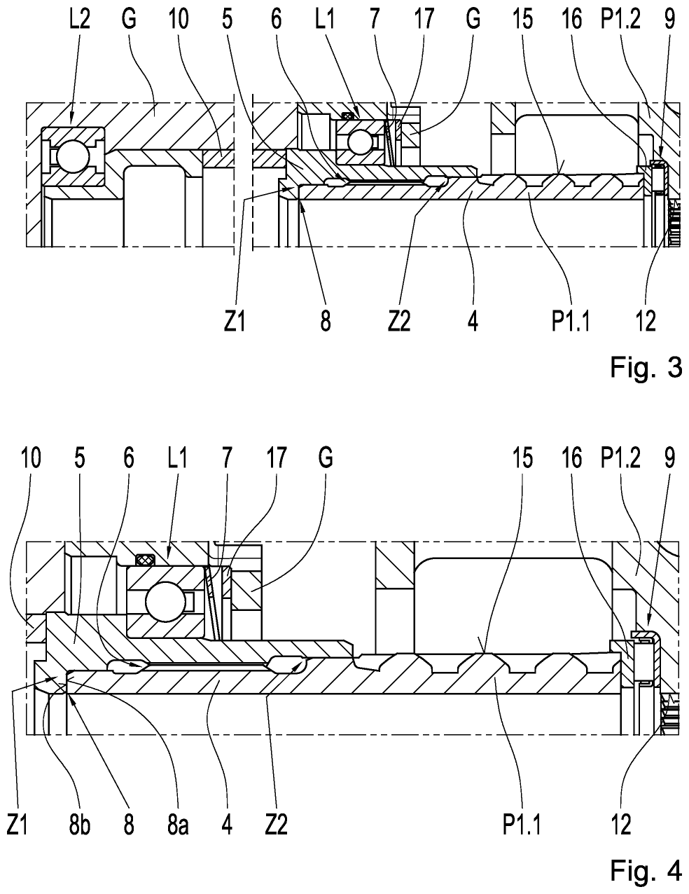

The rotor 10 of the prime mover 2 is connected to a drive shaft 5 (shown in FIG. 3 and FIG. 4) for conjoint rotation, the drive shaft 5 being mounted for rotation with respect to a positionally fixed component G via two bearing elements L1, L2. The bearing elements L1, L2 are grooved ball bearings and support the drive shaft 5 partially radially and partially axially against the positionally fixed component G. The positionally fixed component G is to be understood to be a housing of the drive train 1.

The differential 18 has a first planetary gear set P1, which includes multiple gear set elements, and a second planetary gear set P2, which also includes multiple gear set elements and which is operatively connected to the first planetary gear set P1. A first output torque is transmittable onto the first output shaft A1 by the first planetary gear set P1. A support torque of the first planetary gear set P1 is convertible in the second planetary gear set P2 such that a second output torque, which corresponds to the first output torque, is transmittable onto the second output shaft A2.

In the present example, the two planetary gear sets P1, P2 of the differential 18 and of the transmission 3 are each in the form of a negative planetary gear set. The first gear set element on the first planetary gear set P1 is a first sun gear P1.1, the second gear set element is a first planet carrier P1.2 and the third gear set element is a first ring gear P1.3, wherein multiple first planet gears P1.4, which are meshed with the first sun gear P1.1 and the first ring gear P1.3, are rotatably mounted on the first planet carrier P1.2. The first output shaft A1 is guided axially through the first sun gear P1.1 in the first planetary gear set P1, the input shaft 4 of the transmission 3 and the drive shaft 5 of the prime mover 2. Therefore, the first sun gear P1.1 is in the form of a ring gear and the input shaft 4, which is connected thereto for conjoint rotation, and the drive shaft 5 are each in the form of a hollow shaft. Furthermore, a second sun gear P2.1 as the first gear set element, a second planet carrier P2.2 as the second gear set element, and a second ring gear P2.3 as the third gear set element are arranged at the second planetary gear set P2, wherein multiple second planet gears P2.4, which are meshed with the second sun gear P2.1 and the second ring gear P2.3, are rotatably arranged on the second planet carrier P2.2. The planet gears P1.4, P2.4 are rotatably mounted via respective planet shafts (not shown here) on the associated planet carrier P1.2, P2.2. The gear set elements in the planetary gear sets P1, P2 are helically toothed.

The first sun gear P1.1 is integrally connected to the input shaft 4, which is coupled to the drive shaft 5 via a spline 6. The spline 6 between the input shaft 4 and the drive shaft 5 is a rotationally fixed and axially movable connection. The spline 6 is arranged axially between a first centering Z1 and a second centering Z2. The centerings Z1, Z2, in the form of a press fit, minimize radial play between the drive shaft 5 and the input shaft 4. The centerings Z1, Z2 ensure smoother operation of the input shaft 4 at high rotational speeds and low load. One of the two centerings Z1, Z2 can be dispensed with depending on the system requirements. Torque is transmitted between the drive shaft 5 and the input shaft 4 by the spline 6. Under load, the spline 6 also functions to center the drive shaft 5 relative to the input shaft 4. In the present case, the input shaft 4 has been pressed into the drive shaft 5.

The spline 6 and the centerings Z1, Z2 are also arranged axially between a toothing 15 of the first sun gear P1.1 and an axial stop 8. The axial stop 8 has an end-face and fully circumferential first stop surface 8a on the drive shaft 5 and an end-face and fully circumferential second stop surface 8b on the input shaft 4. In the present example, the axial stop 8 is designed to axially support the first sun gear P1.1 against the drive shaft 5 in one torque direction of the drive train 1.

The input shaft 4 and the first sun gear P1.1 are supported axially against the first planet carrier P1.2 via an axial bearing 9, which is in the form of an axial needle bearing. A thrust washer 16 is arranged axially between the axial bearing 9 and the first sun gear P1.1, so that axial play can be adjusted. When axial play is not to be adjusted, the thrust washer 16 can be dispensed with. The first planet carrier P1.2 is connected to the first output shaft A1 for conjoint rotation via a second spline 12. The first ring gear P1.3 is integrally connected to the second sun gear P2.1. The second planet carrier P2.2 is rotationally fixed at the positionally fixed component G, and the second ring gear P2.3 is at least indirectly connected to the second output shaft A2 for conjoint rotation.

The first bearing element L1 for mounting the drive shaft 5 is arranged axially between the prime mover 2 and the transmission 3, and the second bearing element L2 for mounting the drive shaft 5 is arranged on an opposite side of the prime mover 2 with respect to the first bearing element L1. Therefore, the first bearing element L1 is arranged on the right and the second bearing element L2 is arranged on the left in the schematic view according to FIG. 3, in which the prime mover 2 is not shown except for the rotor 10. The first bearing element L1 is axially preloaded towards the prime mover 2 by a spring element 7, which is in the form of a wave spring, in order to secure or to hold the drive shaft 5 in axial position and in order to preload the bearing elements L1, L2, which are in the form of grooved ball bearings in this case. The second bearing element L2 is simultaneously axially supported against the positionally fixed component G. The preload is therefore applied at the right bearing element L1. When there is preload at the first bearing element L1, the axial position of the drive shaft 5 does not change when there is a switch between traction and coasting. An adjusting shim 17 is arranged between the spring element 7 and the positionally fixed component G, against which the spring element 7 is axially supported. A spring force of the spring element 7 is adjustable via the adjusting shim 17.

In this example, in the traction operation, the input shaft 4 presses axially via the helical teeth of the gear set elements against the axial bearing 9, which has a greater load-bearing capacity. In the coasting operation, however, the input shaft 4 presses via the drive shaft 5 against the second bearing element L2, which is axially supported against the positionally fixed component G.

Axial impacts on the drive shaft 5, for example, due to lateral acceleration, are therefore initially absorbed, in the traction operation, by the spring element 7 and the first bearing element L1 and dissipated at the positionally fixed component G. In the case of stronger impacts, the axial gap between the first stop surface 8a on the drive shaft 5 and the second stop surface 8b on the input shaft 4 closes. In other words, force is transmitted axially between the input shaft 4 and the output shaft 5. In the traction operation, axial force is absorbed via the axial bearing 9 which is located behind the first sun gear P1.1 and dissipated into the positionally fixed component G, specifically the transmission housing in this case. In the traction operation, the forces on the axial bearing 9 from the gear set elements in both planetary gear sets P1, P2 cancel each other out. In the coasting operation, the first sun gear P1.1 is moved towards the drive shaft 5. The first bearing element L1 transmits only radial forces, and the second bearing element L2 can transmit radial forces and axial forces. The spring element 7 is protected by the axial stop 8 against full compression in the event of an axial shock towards the transmission.

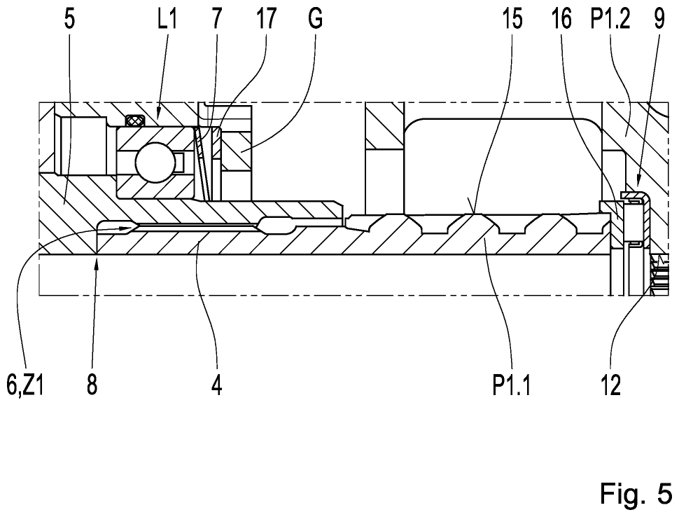

FIG. 5 shows an alternative exemplary embodiment of the drive train 1. The only difference from the first example embodiment according to FIG. 1 through FIG. 4 is the design of the connection between the drive shaft 5 of the prime mover 2 and the input shaft 4 of the transmission 3, the connection transmitting a torque and axial forces. Specifically, centerings in the form of a press fit according to FIG. 3 and FIG. 4 are dispensed with. Instead, a single centering Z1 is implemented as a tooth tip centering on the spline 6. By the tooth tip centering Z1, the input shaft 4 is radially secured and aligned on the drive shaft 5.

The invention is not limited to the disclosed embodiments. Other embodiments or variations will be apparent to those skilled in the art from the use of the present invention and from a detailed analysis of the drawings, the description and the patent claims. In particular, those skilled in the art recognize that the drive shaft 5 can be arranged in the region of the first spline 6 spatially within the input shaft 4. The axial stop is adapted accordingly thereon. It is also conceivable that the second axle 11b of the motor vehicle 13 also has a drive train 2 according to example aspects of the invention.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

1 drive train
2 prime mover
3 transmission
4 input shaft
5 drive shaft
6 spline
7 spring element
8 axial stop
8a first stop surface on the drive shaft
8b second stop surface on the input shaft
9 axial bearing
10 rotor
11a first axle
11b second axle
12 second spline
13 motor vehicle
14 wheel
15 toothing
16 thrust washer
17 adjusting shim
18 differential
A1 first output shaft
A2 second output shaft
G positionally fixed component
L1 first bearing element
L2 second bearing element
P1 first planetary gear set
P1.1 sun gear in the first planetary gear set
P1.2 planet carrier in the first planetary gear set
P1.3 ring gear in the first planetary gear set
P1.4 planet gear in the first planetary gear set
P2 second planetary gear set
P2.1 sun gear in the second planetary gear set
P2.2 planet carrier in the second planetary gear set
P2.3 ring gear in the second planetary gear set
P2.4 planet gear in the second planetary gear set
Z1 first centering
Z2 second centering

1-15: (canceled)

16. A drive train (1) for a motor vehicle (13), comprising:
a prime mover (2) comprising a drive shaft (5); and
a transmission (3) comprising an input shaft (4) and a first planetary gear set (P1) with a plurality of gear set elements that include a sun gear (P1.1), a planet carrier (P1.2), and a ring gear (P1.3), the input shaft (4) connected to one of the plurality of gear set elements of the first planetary gear set (P1) for conjoint rotation,
wherein the drive shaft (5) is configured for at least indirectly transmitting drive power onto the input shaft (4), and the drive shaft (5) is connected via a spline (6) to the input shaft (4) for conjoint rotation, and
wherein the spline (6) is arranged axially between a toothing (15) of a first gear set element of the plurality of gear set elements of the first planetary gear set (P1) and an axial stop (8) configured for axially supporting the input shaft (4) against the drive shaft (5) in one torque direction.

17. The drive train (1) of claim 16, wherein the prime mover (2) comprises an electric machine, and the drive shaft (5) comprises a rotor shaft of the electric machine.

18. The drive train (1) of claim 17, wherein:
the drive shaft (5) is rotatably mounted in a positionally fixed component (G) via a first bearing element (L1) and a second bearing element (L2);
the first bearing element (L1) is arranged axially between the prime mover (2) and the transmission (3); and
the second bearing element (L2) is arranged opposite the first bearing element (L1) about the prime mover (2).

19. The drive train (1) of claim 19, wherein the first bearing element (L1) and the second bearing element (L2) are axially preloaded by a spring element (7).

20. The drive train (1) of claim 16, wherein the input shaft (4) is formed as one piece with the first gear set element of the first planetary gear set (P1).

21. The drive train (1) of claim 16, wherein:
the transmission (3) further comprises a second planetary gear set (P2) operatively connected to the first planetary gear set (P1) and including a plurality of gear set elements with a sun gear (P2.1), a planet carrier (P2.2) and a ring gear (P2.3);
a second gear set element of the first planetary gear set (P1) is at least indirectly connected to a first output shaft (A1) for conjoint rotation, and a third gear set element of the first planetary gear set (P1) is at least indirectly connected to a first gear set element of the second planetary gear set (P2) for conjoint rotation;
a second gear set element of the second planetary gear set (P2) is connected to a positionally fixed component (G) for conjoint rotation, and a third gear set element of the second planetary gear set (P2) is at least indirectly connected to a second output shaft (A) for conjoint rotation; and
a first output torque is at least indirectly transmittable onto the first output shaft (A1) by the first planetary gear set (P1), and a support torque of the first planetary gear set (P1) is convertible in the second planetary gear set (P2) such that a second output torque, which corresponds to the first output torque, is transmittable onto the second output shaft (A2).

22. The drive train (1) of claim 21, wherein the first gear set element of the first planetary gear set (P1) is supported with respect to a second gear set element of the first planetary gear set (P1) via an axial bearing (9).

23. The drive train (1) of claim 22, wherein a thrust washer (16) is arranged axially between the axial bearing (9) and the first gear set element of the first planetary gear set (P1).

24. The drive train (1) of claim 21, wherein the first gear set element of the first planetary gear set (P1, P2) is the sun gear (P1.1, P2.1), the second gear set element of the first planetary gear set (P1, P2) is the planet carrier (P1.2, P2.2), and the third gear set element of the first planetary gear set (P1, P2) is the ring gear (P1.3, P2.3).

25. The drive train (1) of claim 16, wherein the input shaft (4) is radially secured at the drive shaft (5), or vice versa, via at least one first centering (Z1).

26. The drive train (1) of claim 25, wherein the at least one first centering (Z1) comprises a tooth tip centering on the spline (6).

27. The drive train (1) of claim 25, wherein the input shaft (4) is radially secured at the drive shaft (5), or vice versa, via at least one second centering (Z2).

28. The drive train (1) of claim 25, wherein:
the input shaft (4) is radially secured at the drive shaft (5), or vice versa, via at least one first centering (Z1);
the input shaft (4) is radially secured at the drive shaft (5), or vice versa, via at least one second centering (Z2); and
the spline (6) is arranged axially between the at least one first and second centerings (Z1, Z2).

29. The drive train (1) of claim 16, wherein at least the sun gear (P1.1) of the first planetary gear set (P1) is helically toothed.

30. A motor vehicle (13), comprising the drive train (1) of claim 16.
